(19) United States
(12) Patent Application Publication
(10) Pub. No.: US 2026/0241414 A1
(43) Pub. Date: Aug. 20, 2026

(54) ULTRASONIC TRANSDUCER ARRAY

(71) Applicant: Niterra Co., Ltd., Nagoya-shi, Aichi (JP)

(72) Inventors: Ryo SUZUKI, Nagoya-shi (JP); Asuka TSUJII, Nagoya-shi (JP); Yuichiro HANAWA, Nagoya-shi (JP); Shinsuke ITOH, Nagoya-shi (JP); Takashi KASASHIMA, Nagoya-shi (JP); Toshihito SONOBE, Nagoya-shi (JP)

(21) Appl. No.: 19/160,957

(22) PCT Filed: Jul. 18, 2024
(86) PCT No.: PCT/JP2024/025776

§ 371 Date: Aug. 29, 2025

(30) Foreign Application Priority Data
Aug. 16, 2023 (JP) 2023-132514

(51) Int. Cl. B06B 1/06

(52) U.S. Cl. CPC B06B 1/0622

(57) ABSTRACT

An ultrasonic transducer array includes: a plurality of units each of which includes a piezoelectric element and a vibration plate; a first electricity conducting path electrically connected to each of the vibration plates; and a second electricity conducting path electrically connected to each of electrodes provided on second main faces of the piezoelectric elements. The first electricity conducting path includes an electricity conducting member disposed on a side opposite the vibration plates with the piezoelectric elements intervening therebetween, and a plurality of first spring members individually disposed between each of the plurality of vibration plates and the electricity conducting member. A first end of each of the plurality of first spring members is in contact with a corresponding one of the plurality of vibration plates, and a second end of each of the plurality of first spring members is in contact with the electricity conducting member in common.

### TECHNICAL FIELD

The present invention relates to an ultrasonic transducer array.

### BACKGROUND ART

Conventionally, an ultrasonic transducer used for transmission and reception of ultrasonic waves has been known. For example, an ultrasonic transducer described in Patent Document 1 listed below includes a piezoelectric element, a vibration plate, and a pair of terminals. Of the pair of terminals, one terminal is electrically connected to one electrode of the piezoelectric element, and the other terminal is electrically connected to the vibration plate which is in contact with the other electrode of the piezoelectric element.

### PRIOR ART DOCUMENT

### Patent Document

Patent Document 1: JPH04-187000A.

### SUMMARY OF THE INVENTION

### Problem to be Solved by the Invention

In the case where an ultrasonic transducer array is constituted by arranging two or more ultrasonic transducers as described above on a substrate, a large number of terminals are densely disposed on one face of the substrate. Therefore, there has been a problem that wiring and space reduction are difficult.

The present invention has been completed based on the above circumstances, and an object of the present invention is to provide an ultrasonic transducer array that can avoid congestion of terminals.

### Means for Solving the Problem

An ultrasonic transducer array of the present invention includes:

a plurality of units each of which includes a piezoelectric element having electrodes provided on a first main face and a second main face on opposite sides, and a vibration plate joined to the first main face of the piezoelectric element and electrically connected to the electrode provided on the first main face;

a first electricity conducting path electrically connected to each of the vibration plates of the plurality of units; and

a second electricity conducting path electrically connected to each of the electrodes provided on the second main faces of the piezoelectric elements of the plurality of units,

wherein the first electricity conducting path includes an electricity conducting member disposed on a side opposite the vibration plates with the piezoelectric elements intervening therebetween, and a plurality of first spring members individually disposed between each of the plurality of vibration plates and the electricity conducting member, and

wherein a first end of each of the plurality of first spring members is in contact with a corresponding one of the plurality of vibration plates, and a second end of each of the plurality of first spring members is in contact with the electricity conducting member in common.

### Effect of the Invention

According to the present invention, congestion of terminals can be avoided by providing a terminal on a common electricity conducting member, as compared with the case where a terminal is provided for each of a plurality of first spring members.

### BRIEF DESCRIPTION OF THE DRAWINGS

FIG. 1 Sectional view showing an ultrasonic transducer array in Embodiment 1.

FIG. 2 View showing the positional relation among piezoelectric elements, vibration plates, a first electricity conducting path, and a second electricity conducting path.

FIG. 3 Sectional view showing an ultrasonic transducer array in Embodiment 2.

FIG. 4 View showing the positional relation among piezoelectric elements, vibration plates, a first electricity conducting path, and a second electricity conducting path.

FIG. 5 Sectional view showing an ultrasonic transducer array in Embodiment 3.

### MODES FOR CARRYING OUT THE INVENTION

Preferred modes of the present invention are shown below.

[1] An ultrasonic transducer array of the present invention includes:

a plurality of units each of which includes a piezoelectric element having electrodes provided on a first main face and a second main face on opposite sides, and a vibration plate joined to the first main face of the piezoelectric element and electrically connected to the electrode provided on the first main face;

a first electricity conducting path electrically connected to each of the vibration plates of the plurality of units; and

a second electricity conducting path electrically connected to each of the electrodes provided on the second main faces of the piezoelectric elements of the plurality of units,

wherein the first electricity conducting path includes an electricity conducting member disposed on a side opposite the vibration plates with the piezoelectric elements intervening therebetween, and a plurality of first spring members individually disposed between each of the plurality of vibration plates and the electricity conducting member, and

wherein a first end of each of the plurality of first spring members is in contact with a corresponding one of the plurality of vibration plates, and a second end of each of the plurality of first spring members is in contact with the electricity conducting member in common.

By virtue of this configuration, congestion of terminals can be avoided by providing a terminal on a common electricity conducting member, as compared with the case where a terminal is provided for each of a plurality of first spring members.

[2] In the ultrasonic transducer array described in the above [1], the second electricity conducting path may include a plurality of second spring members, and a first end of each of the plurality of second spring members may be in contact with the electrode provided on the second main face of each of the plurality of piezoelectric elements. By virtue of this configuration, it is not necessary to connect the second electricity conducting path to the second electrode of the piezoelectric element by soldering. Accordingly, it is possible to prevent occurrence of a connection failure due to solder peeling or the like.

[3] In the ultrasonic transducer array described in the above [2], the second electricity conducting path may include a plurality of rod-shaped members each of which contacts a second end, on a side opposite the first end, of each of the plurality of second spring members, thereby being electrically connected to the second spring member. By virtue of this configuration, the contact state between the second spring member and the rod-shaped member is likely to be stable. Therefore, it is possible to prevent occurrence of a connection failure of the second electricity conducting path.

[4] In the ultrasonic transducer array described in any of the above [1] to [3], the second electricity conducting path may extend to a side of the electricity conducting member opposite the piezoelectric elements. By virtue of this configuration, the terminals of the second electricity conducting path can be provided on the side of the electricity conducting member opposite the piezoelectric elements. Accordingly, it is possible to avoid congestion of the terminals of the second electricity conducting path in a region on the piezoelectric element side of the electricity conducting member.

[5] In the ultrasonic transducer array described in the above [4] , the electricity conducting member may have a through hole that is formed from a side where the piezoelectric elements are present to a side opposite the piezoelectric elements, and the second electricity conducting path may extend through the through hole. By virtue of this configuration, it is possible to reduce a removed portion of the electricity conducting member as compared with the case where a cutout or the like for passing the second electricity conducting path is formed in the electricity conducting member.

[6] The ultrasonic transducer array described in any of the above [1] to [5] may further comprise an insulating member that covers the electricity conducting member, and an opening for partially exposing the electricity conducting member may be formed in a portion of the insulating member, which portion covers a side of the electricity conducting member opposite the piezoelectric elements. By virtue of this configuration, heat transferred to the electricity conducting member by the first spring members is dissipated into the air through the opening. Accordingly, it is possible to suppress deterioration of the ultrasonic transducer array due to heat of the piezoelectric elements.

### embodiment 1

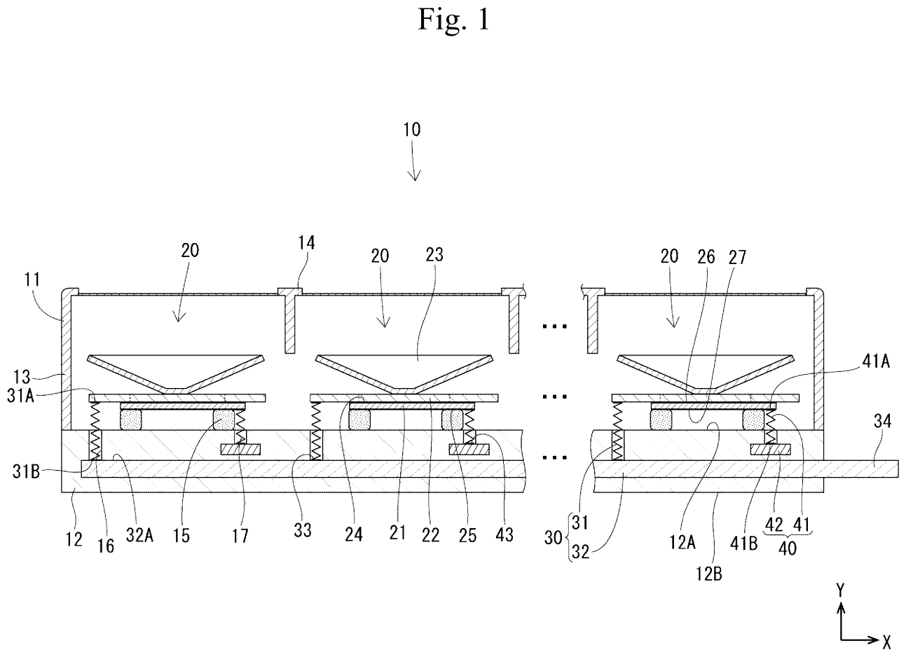

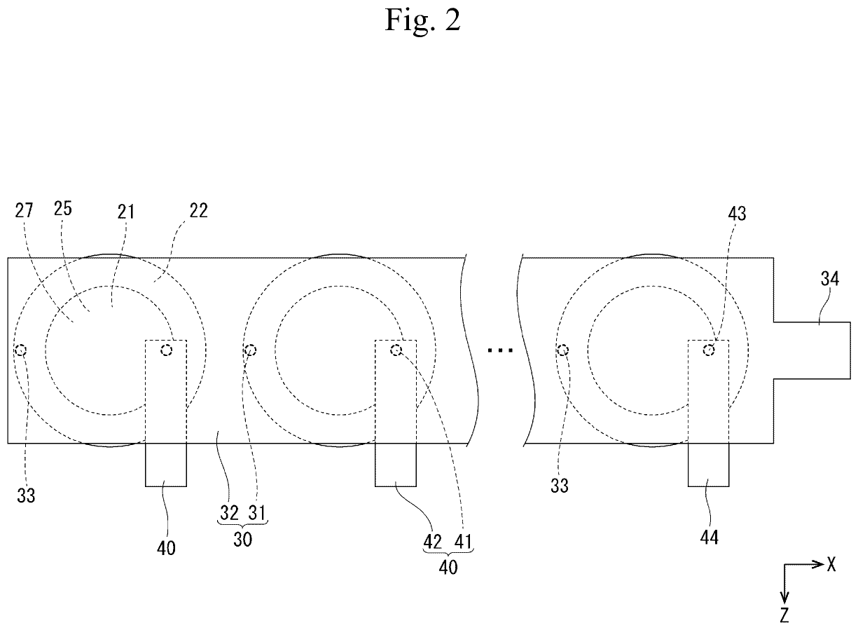

Embodiment 1 in which the present invention is embodied will be described in detail with reference to FIGS. 1 and 2. An ultrasonic transducer array 10 in the present embodiment is used in, for example, an ultrasonic device for medical use or industrial use. When a drive signal is applied to the ultrasonic transducer array 10, the ultrasonic transducer array 10 generates an ultrasonic wave. When the ultrasonic transducer array 10 receives an ultrasonic wave, the ultrasonic transducer array 10 converts the ultrasonic wave to an electrical signal. The ultrasonic transducer array 10 includes two or more units (herein referred to as ultrasonic transducers 20) each having a piezoelectric element 21 and a vibration plate 22.

Each ultrasonic transducer 20 has the piezoelectric element 21, the vibration plate 22, and a resonator 23. The piezoelectric element 21 is formed of PZT (lead zirconate titanate), KNN (sodium potassium niobate), or the like, and has an approximately circular plate-like shape. The piezoelectric element 21 has electrodes 26 and 27 which are respectively disposed on a first main face (herein referred to as the first face 24) and a second main face (herein referred to as the second face 25) on opposite sides. The first face 24 is formed on one side of the piezoelectric element 21 in the thickness direction, and the second face 25 is formed on the other side of the piezoelectric element 21 in the thickness direction. The first face 24 and the second face 25 each have a circular shape and are concentric with each other. The first face 24 and the second face 25 are parallel to each other. The area of the first face 24 is equal to the area of the second face 25.

In the description of each constituent member below, the side where the first face 24 of the piezoelectric element 21 is formed will be referred to as the upper side, and the side where the second face 25 is formed will be referred to as the lower side. The Y axis shown in the drawings is parallel to the thickness direction of the piezoelectric element 21. The X axis shown in the drawings is orthogonal to the thickness direction of the piezoelectric element 21. In the description, the positive direction side in the X axis will be referred to as the right side, and the negative direction side in the X axis will be referred to as the left side. The Z axis shown in the drawings is orthogonal to the X axis and the Y axis. In the description, the positive direction side in the Z axis will be referred to as the front side, and the negative direction side in the Z axis will be referred to as the rear side.

The piezoelectric element 21 has the first electrode 26 and the second electrode 27. The first electrode 26 and the second electrode 27 are each formed by vapor deposition, plating, sputtering, baking, or the like, of gold, silver, copper, tin, etc. The first electrode 26 and the second electrode 27 each have a circular shape. The first electrode 26 is formed over the entirety of the first face 24 of the piezoelectric element 21. The second electrode 27 is formed over the entirety of the second face 25 of the piezoelectric element 21.

The vibration plate 22 has electrical conductivity and is made of, for example, a metal plate. The vibration plate 22 is superimposed on the first face 24 of the piezoelectric element 21 and is joined thereto by an unillustrated adhesive or the like. The vibration plate 22 is electrically connected to the first electrode 26. The vibration plate 22 has a circular shape which is larger than the piezoelectric element 21 in the plan view. The vibration plate 22 is disposed coaxially with the piezoelectric element 21. The vibration plate 22 has an outer diameter larger than that of the piezoelectric element 21. The outer periphery of the vibration plate 22 is a free end, and the ultrasonic transducer 20 is a so-called open type. The vibration plate 22 more easily vibrates as compared with the vibration plate of a closed-type ultrasonic transducer in which the outer periphery of the vibration plate is fixed.

The resonator 23 is made of a metal and has a conical shape. The resonator 23 is fixed to the center of an upper surface of the vibration plate 22 by an unillustrated adhesive. The resonator 23 resonates with vibrations of the vibration plate 22, thereby generating ultrasonic waves.

The ultrasonic transducer array 10 includes two or more ultrasonic transducers 20, a case 11, a first electricity conducting path 30, and a second electricity conducting path 40. The ultrasonic transducers 20 are arranged at equal intervals in the left-right direction. The ultrasonic transducers 20 are disposed on the same plane. The ultrasonic transducers 20 have the same structure, size, and shape.

The case 11 is made of a synthetic resin, contains the ultrasonic transducers 20 therein, and holds the ultrasonic transducers 20. The case 11 protects the ultrasonic transducers 20 so as to prevent foreign substances from coming into contact with the ultrasonic transducers 20.

The case 11 has an insulating member 12 disposed below the ultrasonic transducers 20, a circumferential wall 13 which surrounds the ultrasonic transducers 20, and an upper wall 14 disposed above the ultrasonic transducers 20. Multiple openings are formed in the upper wall 14. Through the openings of the upper wall 14, ultrasonic waves are sent from the interior of the case 11 to the outside, and ultrasonic waves enter the interior of the case 11 from the outside.

The insulating member 12 has insulating properties and covers most of the first electricity conducting path 30 and the second electricity conducting path 40. The insulating member 12 has a shape of a plate extending in the front-rear direction and the left-right direction. The insulating member 12 has an upper surface 12A and a lower surface 12B which are parallel to the lower surface (the second surface 25) of the piezoelectric element 21 and the lower surface of the vibration plate 22. The insulating member 12 supports the ultrasonic transducers 20 via fixing members 15.

Each fixing member 15 is bonded to the piezoelectric element 21 and the insulating member 12. The fixing member 15 supports the piezoelectric element 21 at a lifted position relative to the upper surface 12A of the insulating member 12. The fixing member 15 supports an outer peripheral edge portion of the piezoelectric element 21. The fixing member 15 is an adhesive having insulating properties and elasticity. The fixing member 15 is, for example, rubber, resin, or the like kneaded with carbon black, calcium carbonate, or the like added thereto.

The first electricity conducting path 30 is electrically connected to the vibration plate 22 of each ultrasonic transducer 20. The first electricity conducting path 30 includes a plurality of first spring members 31 and one electricity conducting member 32.

Each first spring member 31 is a compression coil spring formed by spirally winding a wire having electrical conductivity, such as metal wire. Each first spring member 31 is attached in an orientation determined such that the first spring member 31 exhibits elasticity in the direction in which the vibration plate 22 and the electricity conducting member 32 face each other. The first spring member 31 in the attached state is sandwiched and compressed by the vibration plate 22 and the electricity conducting member 32. An upper end (first end) 31A of the first spring member 31 is elastically in contact with the lower surface of the vibration plate 22 and is electrically connected to the vibration plate 22. A lower end (second end) 31B of the first spring member 31 is elastically in contact with the upper surface 32A of the electricity conducting member 32 and is electrically connected to the electricity conducting member 32.

The first spring member 31 is in contact with the vicinity of the node of the vibration of the vibration plate 22. The node of vibration means a portion where the amount of displacement in the thickness direction when the vibration plate 22 vibrates is the smallest or a portion where there is no vibration when the vibration plate 22 vibrates. The node is univocally determined in accordance with the shapes and materials of the piezoelectric element 21 and the resonator 23.

The first spring member 31 is inserted into a first hole 16 formed in the insulating member 12. The first hole 16 of the insulating member 12 penetrates the insulating member 12 in the up-down direction, from the upper surface 12A of the insulating member 12 to the upper surface 32A of the electricity conducting member 32. In the attached state, at least half of the lower side of the length dimension of the first spring member 31 in the up-down direction is located within the first hole 16 of the insulating member 12. By virtue of this configuration, the first spring member 31 can be prevented from coming off the insulating member 12. In the attached state, an upper portion of the first spring member 31 protrudes above the upper surface 12A of the insulating member 12.

The electricity conducting member 32 has the shape of a plate having plate surfaces extending in the left-right direction and the front-rear direction. Upper and lower surfaces of the electricity conducting member 32 are covered by the insulating member 12. In the plan view, the electricity conducting member 32 has an approximately rectangular shape in which its length in the left-right direction is larger than its length in the front-rear direction. The electricity conducting member 32 is formed of a material having electrical conductivity. The electricity conducting member 32 is formed by, for example, punching a metal plate. The electricity conducting member 32 is disposed under the plurality of ultrasonic transducers 20. The electricity conducting member 32 has a size equal to or greater than the size of the region where all the ultrasonic transducers 20 are disposed. The plate surface of the electricity conducting member 32 and the plate surface of each vibration plate 22 are parallel to each other. The electricity conducting member 32 has a plurality of contact points 33 each of which is electrically connected to a corresponding one of the plurality of first spring members 31. The number of the contact points 33 is equal to the number of the first spring members 31.

The electricity conducting member 32 is provided with a first terminal 34 integrally formed therewith. The first terminal 34 protrudes rightward from a right end edge of the electricity conducting member 32. The first terminal 34 is formed, for example, simultaneously at the time of punching of the electricity conducting member 32. The first terminal 34 is disposed on the same plane as the electricity conducting member 32. The first terminal 34 has a rectangular shape in the plan view. The first terminal 34 protrudes rightward from a right end surface of the insulating member 12.

The second electricity conducting path 40 is electrically connected to the second electrode 27 of the piezoelectric element 21 of each ultrasonic transducer 20. The second electricity conducting path 40 includes a plurality of second spring members 41 and a plurality of plate-shaped members 42.

Each second spring member 41 is a compression coil spring formed by spirally winding a wire having electrical conductivity, such as metal wire. Each second spring member 41 is attached in an orientation determined such that the second spring member 41 exhibits elasticity in the direction in which the piezoelectric element 21 and the plate-shaped member 42 face each other. The second spring member 41 in the attached state is sandwiched and compressed by the piezoelectric element 21 and the plate-shaped member 42. An upper end (first end) 41A of the second spring member 41 is elastically in contact with the second electrode 27 of the piezoelectric element 21 and is electrically connected to the second electrode 27. A lower end (second end) 41B of the second spring member 41 is elastically in contact with the upper surface of the plate-shaped member 42 and is electrically connected to the plate-shaped member 42.

The second spring member 41 is in contact with the vicinity of the outer circumferential edge of the piezoelectric element 21. The second spring member 41 is inserted into a second hole 17 of the insulating member 12. The second hole 17 of the insulating member 12 penetrates the insulating member 12 from the upper surface 12A of the insulating member 12 to the upper surface of the plate-shaped member 42. In the attached state, a lower portion of the second spring member 41 is disposed in the second hole 17, and an upper portion of the second spring member 41 protrudes above the upper surface 12A of the insulating member 12.

In the attached state, the compressed length of the first spring member 31 is different from the compressed length of the second spring member 41. In other words, the pressure (contact pressure) at which the first spring member 31 and the vibration plate 22 contact each other differs from the pressure (contact pressure) at which the second spring member 41 and the piezoelectric element 21 contact each other. By virtue of this, the contact pressure near the node of vibration can be increased, and the contact pressure at positions away from the node of vibration can be reduced.

The plurality of plate-shaped members 42 is individually disposed under each of the plurality of second spring members 41. The upper and lower surfaces of the plate-shaped member 42 are covered by the insulating member 12. The number of the plate-shaped members 42 is the same as the number of the second spring members 41. Each plate-shaped member 42 is formed from an electrically conductive material into a plate-like shape. The plate-shaped member 42 is formed by, for example, punching a metal plate. The plate surfaces of plate-shaped member 42 is parallel to the second surface 25 of the piezoelectric element 21. The plate-shaped members 42 are disposed away from the electricity conducting member 32 to the upper side. The plate-shaped members 42 are insulated from the electricity conducting member 32 by the insulating member 12.

Each plate-shaped member 42 has an approximately rectangular shape in which its length in the front-rear direction is larger than its length in the left-right direction. The plate-shaped members 42 have the same size and shape. The plate-shaped members 42 are disposed at equal intervals in the left-right direction. Each plate-shaped member 42 has a contact point 43 which is electrically connected to the second spring member 41. The contact point 43 is provided on the rear end side of the upper surface of each plate-shaped member 42. The contact point 43 is disposed at the position of the second hole 17 of the insulating member 12. The contact point 43 faces the outer edge portion of the piezoelectric element 21 in the up-down direction.

A front end portion of each plate-shaped member 42 protrudes toward the front side from a front face of the insulating member 12. A portion of each plate-shaped member 42 protruding from the insulating member 12 constitutes a second terminal 44. The protruding direction of the second terminal 44 is orthogonal to the protruding direction of the first terminal 34. The second terminal 44 has a rectangular shape in the plan view. The second terminals 44 are disposed at equal intervals in the left-right direction. The second terminals 44 adjacent to each other in the left-right direction are spaced from each other by a distance necessary to prevent a short circuit during high-voltage drive.

The first terminal 34 and the second terminals 44 are electric signal input/output terminals. A negative-pole-side electricity conducting path, not illustrated, is connected to the first terminal 34. A positive-pole-side electricity conducting path, not illustrated, is connected to the second terminals 44.

Next, the action and effect of the embodiment configured as described above will be described. The ultrasonic transducer array 10 includes the plurality of ultrasonic transducers 20, each having the piezoelectric element 21 and the vibration plate 22, the first electricity conducting path 30, and the second electricity conducting path 40. The piezoelectric element 21 has the first electrode 26 and the second electrode 27 on the first face 24 and the second face 25 on opposite sides. The vibration plate 22 is joined to the first face 24 of the piezoelectric element 21 and is electrically connected to the first electrode 26 provided on the first face 24. The first electricity conducting path 30 is electrically connected to each of the vibration plates 22 of the plurality of ultrasonic transducers 20. The second electricity conducting path 40 is electrically connected to each of the second electrodes 27 of the piezoelectric elements 21 of the plurality of ultrasonic transducers 20. The first electricity conducting path 30 includes the electricity conducting member 32 and the plurality of first spring members 31. The electricity conducting member 32 is disposed on the side opposite the vibration plates 22 with the piezoelectric elements 21 intervening therebetween. The plurality of first spring members 31 is individually disposed between each of the plurality of vibration plates 22 and the electricity conducting member 32. The upper end 31A of each of the plurality of first spring members 31 is in contact with a corresponding one of the plurality of vibration plates 22, and the lower end 31B of each of the plurality of first spring members 31 is in contact with the electricity conducting member 32 in common.

By virtue of this configuration, congestion of terminals can be avoided by providing the first terminal 34 on the common electricity conducting member 32, as compared with the case where a terminal is provided for each of the plurality of first spring members 31. Even in the case where the size of the ultrasonic transducer array 10 is reduced, since congestion of the first terminal 34 and the second terminals 44 can be avoided, a short circuit during high-voltage drive can be prevented. In addition, since the first electricity conducting path 30 is electrically connected to the vibration plates 22 by the first spring members 31, it is not necessary to solder the first electricity conducting path 30. Accordingly, it is possible to prevent hinderance of vibration by solder and occurrence of a connection failure due to solder peeling.

The second electricity conducting path 40 includes the plurality of second spring members 41. The upper end 41A of each of the plurality of second spring members 41 is in contact with the second electrode 27 of each of the plurality of piezoelectric elements 21. By virtue of this configuration, it is not necessary to connect the second electricity conducting path 40 to the second electrodes 27 of the piezoelectric elements 21 by soldering. Accordingly, it is possible to prevent occurrence of a connection failure due to solder peeling or the like. In addition, heat generated from the piezoelectric element 21 is quickly transferred to the plate-shaped member 42 by the second spring member 41. Accordingly, it is possible to suppress deterioration of the piezoelectric elements 21 due to heat.

### Embodiment 2

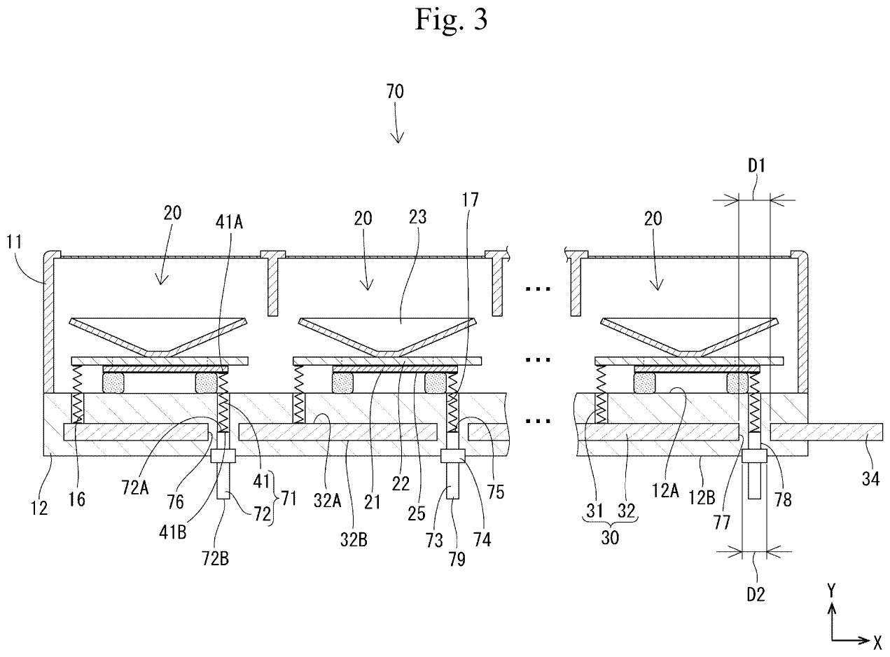

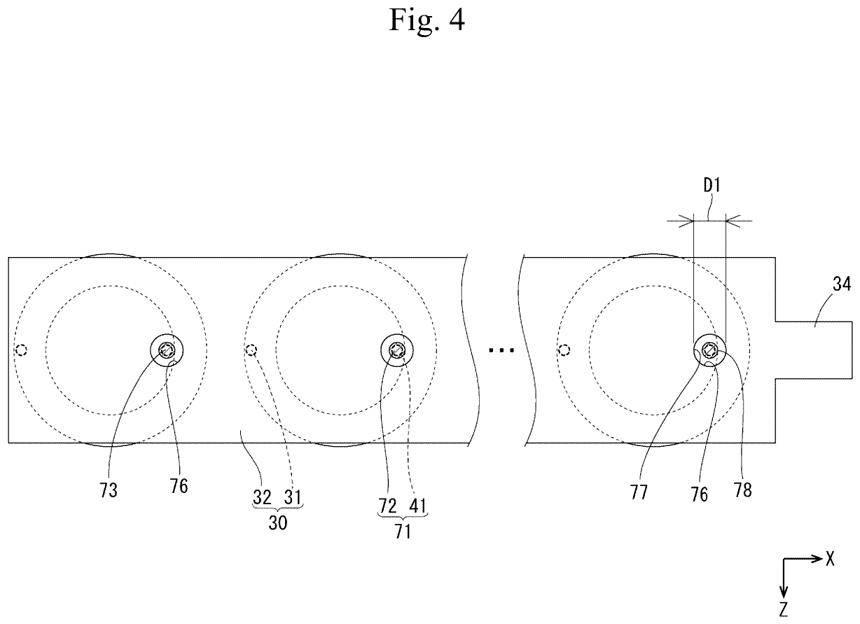

Next, an ultrasonic transducer array 70 according to Embodiment 2 in which the present invention is embodied will be described with reference to FIGS. 3 and 4. A second electricity conducting path 71 of the ultrasonic transducer array 70 of the present embodiment differs from that of Embodiment 1 in the point that the second electricity conducting path 71 has rod-shaped members 72 in place of the plate-shaped members 42 and extends to the lower side of the electricity conducting member 32. The same components as those of Embodiment 1 are denoted by the same reference numerals, and will not be described redundantly.

As in Embodiment 1, the ultrasonic transducer array 70 according to the present embodiment includes two or more ultrasonic transducers 20, a case 11, a first electricity conducting path 30, and the second electricity conducting path 71. As in Embodiment 1, each ultrasonic transducer 20 includes a piezoelectric element 21, a vibration plate 22, and a resonator 23, and the first electricity conducting path 30 includes a plurality of first spring members 31 and one electricity conducting member 32.

The second electricity conducting path 71 includes a plurality of second spring members 41 and the plurality of rod-shaped members 72. The plurality of rod-shaped members 72 is individually disposed under each of the second spring members 41. The number of the rod-shaped members 72 is the same as the number of the second spring members 41. Each rod-shaped member 72 is formed from an electrically conductive material into a rod-like shape. For example, each rod-shaped member 72 is a metal pin. Each rod-shaped member 72 contacts the lower end 41B of the second spring member 41 and is thereby electrically connected to the second spring member 41.

Each rod-shaped member 72 has the shape of an elongated rod extending straight in the up-down direction. Each rod-shaped member 72 has a main body portion 73 and a flange portion 74. The shape of a cross section of each rod-shaped member 72 perpendicular to the up-down direction is approximately circular. The main body portion 73 extends from an upper end 72A to a lower end 72B of the rod-shaped member 72. The outer diameter of the main body portion 73 is constant from the upper end 72A to the lower end 72B. The flange portion 74 is provided at an intermediate position of the rod-shaped member 72 in the up-down direction. The outer diameter of the flange portion 74 is larger than the outer diameter of the main body portion 73. The outer diameters of the flange portion 74 and the main body portion 73 are their maximum widths in an X-Z plane. The rod-shaped members 72 have the same size and shape. The rod-shaped members 72 are disposed at equal intervals in the left-right direction.

Each rod-shaped member 72 has a contact point 75 for contact with the second spring member 41. The contact point 75 is the upper end 72A of each rod-shaped member 72. The contact point 75 is parallel to the second face 25 of the piezoelectric element 21. The contact point 75 faces an outer edge portion of the piezoelectric element 21 in the up-down direction.

The rod-shaped members 72 are embedded in the insulating member 12. The contact point 75 of each rod-shaped member 72 is disposed at an intermediate position of the insulating member 12 in the up-down direction. An upper portion of each rod-shaped member 72 is embedded in the insulating member 12, and a lower portion of each rod-shaped member 72 protrudes downward from the lower surface 12B of the insulating member 12. A lower end portion of each rod-shaped member 72 constitutes a second terminal 79. The second terminals 79 are disposed at equal intervals in the left-right direction. The second terminals 79 adjacent to each other in the left-right direction are spaced from each other by a distance necessary to prevent a short circuit during high-voltage drive.

The rod-shaped members 72 protrude in a direction orthogonal to the X-Z plane which is parallel to the placement plane of the first terminal 34. This configuration enables the space in which the first terminal 34 and the second terminals 79 are disposed to be expanded not only in the plane direction but also in the height direction. Therefore, it is possible to prevent a large number of terminals from congesting on the same plane.

A plurality of through holes 76 is formed in the electricity conducting member 32. Each through hole 76 penetrates the electricity conducting member 32 in the up-down direction from the upper surface 32A to the lower surface 32B. Each through hole 76 has a circular shape in the plan view. Each through hole 76 is disposed coaxially with the second hole 17. The center axis of the rod-shaped member 72 and the center axis of the through hole 76 are the same. The inner diameter D1 of each through hole 76 is larger than the outer diameter D2 of the flange portion 74. In other words, the opening area of the through hole 76 is larger than the projection area of the rod-shaped member 72 as viewed from the lower side of the ultrasonic transducer array 70. By virtue of this, it is possible to prevent proximation of the first electricity conducting path 30 and the second electricity conducting path 71, thereby preventing a short circuit at the time of high-voltage drive.

The distance between a circumferential surface 77 of the through hole 76 and an outer circumferential surface 78 of the rod-shaped member 72 is set to be equal to or greater than a distance necessary to prevent a short circuit during high-voltage drive. By virtue of this, it is possible to more reliably prevent a short circuit between the first electricity conducting path 30 and the second electricity conducting path 71. The distance between the circumferential surface 77 of the through hole 76 and the outer circumferential surface 78 of the rod-shaped member 72 is the shortest distance between the circumferential surface 77 of the through hole 76 and the outer circumferential surface 78 of the rod-shaped member 72 in the X-Z plane.

The second electricity conducting path 71 extends, through the through holes 76 of the electricity conducting member 32, to the lower side (the side opposite the piezoelectric elements 21) of the electricity conducting member 32. The lower end portion of the second spring member 41 and the upper end portion of the rod-shaped member 72 are located in the range of the through hole 76 in the up-down direction.

As described above, in the present embodiment, as in Embodiment 1, the first electricity conducting path 30 includes the electricity conducting member 32 and the plurality of first spring members 31, the plurality of first spring members 31 is individually disposed between each of the plurality of vibration plates 22 and the electricity conducting member 32, the upper end 31A of each of the plurality of first spring members 31 is in contact with a corresponding one of the plurality of vibration plates 22, and the lower ends 31B of the plurality of first spring members 31 are in contact with the electricity conducting member 32 in common. By virtue of this configuration, congestion of terminals can be avoided by providing the first terminal 34 on the common electricity conducting member 32, as compared with the case where a terminal is provided for each of the plurality of first spring members 31.

In addition, the second electricity conducting path 71 includes the plurality of rod-shaped members 72 each of which is electrically connected to the second spring member 41. By virtue of this configuration, the contact state between the second spring member 41 and the rod-shaped member 72 is likely to be stable. Therefore, it is possible to prevent occurrence of a connection failure of the second electricity conducting path 71.

In addition, the second electricity conducting path 71 extends to the lower side of the electricity conducting member 32. This configuration allows the second terminals 79 of the second electricity conducting path 71 to be provided on the lower side of the electricity conducting member 32. Accordingly, it is possible to avoid congestion of the second terminals 79 in a narrow region on the upper side of the electricity conducting member 32.

In addition, the through holes 76 are formed in the electricity conducting member 32 to extend from the upper side to the lower side of the electricity conducting member 32, and the second electricity conducting path 71 extends through the through holes 76. By virtue of this configuration, it is possible to reduce a removed portion of the electricity conducting member 32 as compared with the case where a cutout or the like for passing the second electricity conducting path 71 is formed in the electricity conducting member 32.

### Embodiment 3

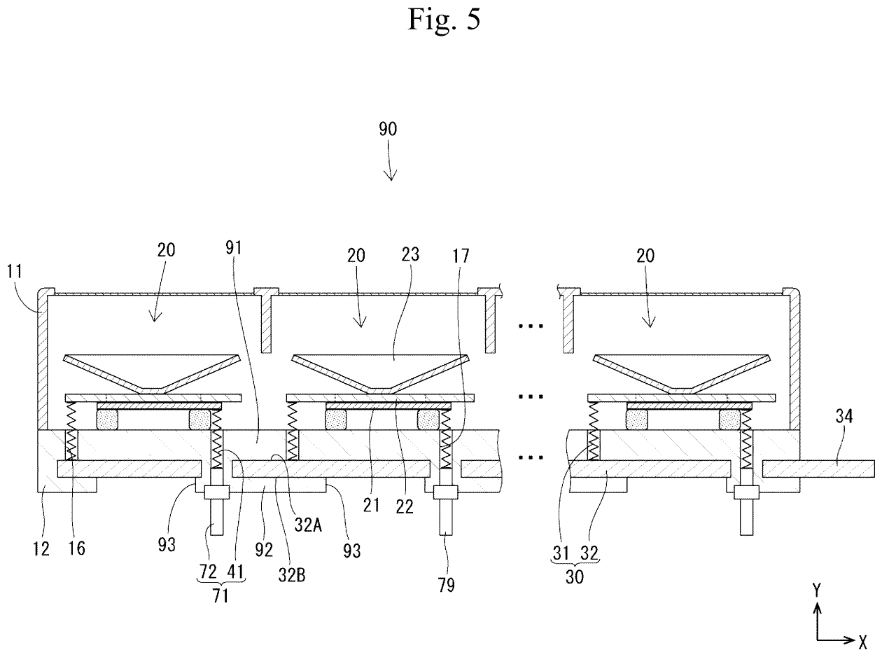

Next, an ultrasonic transducer array 90 according to Embodiment 3 in which the present invention is embodied will be described with reference to FIG. 5. The ultrasonic transducer array 90 of the present embodiment differs from that of Embodiment 2 in the point that openings 93 are formed in a lower surface portion 92 of the insulating member 12, which covers the lower side (the side opposite the piezoelectric elements 21) of the electricity conducting member 32. The same components as those of Embodiment 2 are denoted by the same reference numerals, and will not be described redundantly.

As in Embodiment 2, the ultrasonic transducer array 90 according to the present embodiment includes two or more ultrasonic transducers 20, a case 11, a first electricity conducting path 30, and a second electricity conducting path 71. As in Embodiment 2, each ultrasonic transducer 20 includes a piezoelectric element 21, a vibration plate 22, and a resonator 23, the first electricity conducting path 30 includes a plurality of first spring members 31 and one electricity conducting member 32, and the second electricity conducting path 71 includes a plurality of second spring members 41 and a plurality of rod-shaped members 72.

The insulating member 12 has an upper surface portion 91 which covers the upper side of the electricity conducting member 32 and a lower surface portion 92 which covers the lower side of the electricity conducting member 32. The area of the upper surface portion 91 along the X-Z plane is larger than the area of the upper surface 32A of the electricity conducting member 32. The upper surface portion 91 has a certain thickness on the upper side of the electricity conducting member 32. First holes 16 and second holes 17 are formed in the upper surface portion 91.

The lower surface portion 92 has a certain thickness on the lower side of the electricity conducting member 32. The rod-shaped members 72 are embedded in the lower surface portion 92. A plurality of openings 93 is formed in the lower surface portion 92. The number of the openings 93 is equal to the number of the ultrasonic transducers 20. Each opening 93 is located between the second terminals 79 adjacent to each other. The area of the lower surface portion 92 along the X-Z plane is smaller than the area of the lower surface 32B of the electricity conducting member 32. The lower surface 32B of the electricity conducting member 32 is partially exposed through the openings 93 to the space below the insulating member 12. By virtue of this configuration, it is possible to prevent accumulation of heat inside the case 11.

As described above, in the present embodiment, as in Embodiment 2, congestion of terminals can be avoided by providing the first terminal 34 on the common electricity conducting member 32, as compared with the case where a terminal is provided for each of the plurality first spring members 31. In addition, as in Embodiment 2, since the second electricity conducting path 71 extends to the lower side of the electricity conducting member 32, it is possible to avoid congestion of the second terminals 79 in a narrow region on the upper side of the electricity conducting member 32.

In the ultrasonic transducer array 90, the openings 93, which partially expose the electricity conducting member 32, are formed in the lower surface portion 92 of the insulating member 12. By virtue of this configuration, heat transferred to the electricity conducting member 32 by the first spring members 31 is dissipated into the air through openings 93. Accordingly, it is possible to suppress deterioration of the ultrasonic transducer array 90 due to heat of the piezoelectric elements 21.

### Other Embodiments

The present invention is not limited to the embodiments explained by the above description and the drawings and, for example, embodiments as described below fall within the technical scope of the present invention.

(1) In the above-described embodiments, the vibration plates 22 are separated from one another. This is not limitative, and members for connecting the vibration plates may be provided.

(2) The above-described embodiments show as an example the case where the plurality of ultrasonic transducers 20 is arranged in a row in the left-right direction. This is not limitative, and the arrangement of the plurality of ultrasonic transducers may be changed freely. For example, the plurality of ultrasonic transducers may be arranged in two directions; i.e., in the left-right direction and the front-rear direction, and the ultrasonic transducers are not required to be disposed at equal intervals.

(3) In the above-described embodiments, each piezoelectric element 21 has the shape of an approximately circular plate. This is not limitative, and the piezoelectric element may have the shape of, for example, an approximately rectangular plate.

(4) In the above-described embodiments, each of the ultrasonic transducer arrays 10, 70, and 90 has one electricity conducting member 32. This is not limitative, and each ultrasonic transducer array may have a plurality of electricity conducting members. In this case, each ultrasonic transducer array may be configured such that the ultrasonic transducer array has a plurality of electricity conducting members, and a plurality of first spring members is connected to each electricity conducting member in common. (5) In Embodiment 3 described above, the sizes, positions, etc. of the openings 93 are shown as examples. This is not limitative, and the sizes and positions of the openings may be changed appropriately.

(6) In the above-described embodiments, the manner of formation of the electrodes having different polarities respectively formed on opposite main faces (front and back surfaces) of the piezoelectric element 21 is not limited to the manner in which only one electrode is formed on one main face, but one electrode may be continuously formed to extend from one main face to a portion of the other main face; i.e., may have a so-called folded shape.

### Description of Reference Numerals

10, 70, 90: ultrasonic transducer array
12: insulating member
20: ultrasonic transducer (unit)
21: piezoelectric element
22: vibration plate
24: first face (first main face)
25: second face (second main face)
26: first electrode (electrode provided on the first main face)
27: second electrode (electrode provided on the second main face)
30: first electricity conducting path
31: first spring member
31A: upper end (first end of the first spring member)
31B: lower end (second end of the first spring member)
32: electricity conducting member
40, 71: second electricity conducting path
41: second spring member
41A: upper end (first end of the second spring member)
41B: lower end (second end of the second spring member)
72: rod-shaped member
76: through hole
92: lower surface portion (a portion of the insulating member, which portion covers the side of the electricity conducting member opposite the piezoelectric element)
93: opening

What is claimed is:

1. An ultrasonic transducer array comprising:
a plurality of units each of which includes a piezoelectric element having electrodes provided on a first main face and a second main face on opposite sides, and a vibration plate joined to the first main face of the piezoelectric element and electrically connected to the electrode provided on the first main face;
a first electricity conducting path electrically connected to each of the vibration plates of the plurality of units; and
a second electricity conducting path electrically connected to each of the electrodes provided on the second main faces of the piezoelectric elements of the plurality of units,
wherein the first electricity conducting path includes an electricity conducting member disposed on a side opposite the vibration plates with the piezoelectric elements intervening therebetween, and a plurality of first spring members individually disposed between each of the plurality of vibration plates and the electricity conducting member, and
wherein a first end of each of the plurality of first spring members is in contact with a corresponding one of the plurality of vibration plates, and a second end of each of the plurality of first spring members is in contact with the electricity conducting member in common.

2. An ultrasonic transducer array according to claim 1, wherein the second electricity conducting path includes a plurality of second spring members, and
a first end of each of the plurality of second spring members is in contact with the electrode provided on the second main face of each of the plurality of piezoelectric elements.

3. An ultrasonic transducer array according to claim 2, wherein the second electricity conducting path includes a plurality of rod-shaped members each of which contacts a second end, on a side opposite the first end, of each of the plurality of second spring members, thereby being electrically connected to the second spring member.

4. An ultrasonic transducer array according to claim 1, wherein the second electricity conducting path extends to a side of the electricity conducting member opposite the piezoelectric elements.

5. An ultrasonic transducer array according to claim 4, wherein the electricity conducting member has a through hole that is formed from a side where the piezoelectric elements are present to a side opposite the piezoelectric elements, and
the second electricity conducting path extends through the through hole.

6. An ultrasonic transducer array according to claim 1, further comprising an insulating member that covers the electricity conducting member, wherein an opening for partially exposing the electricity conducting member is formed in a portion of the insulating member, which portion covers a side of the electricity conducting member opposite the piezoelectric elements.
